(19) United States
(12) Patent Application Publication
(10) Pub. No.: US 2026/0049743 A1
(43) Pub. Date: Feb. 19, 2026

(54) GEOTHERMAL HEATING AND COOLING SYSTEM

(71) Applicant: SABIC GLOBAL TECHNOLOGIES B.V., Bergen op Zoom (NL)

(72) Inventors: Ajay Kumar Taraiya, Maastricht (NL); Peter Degenhart, Echt (NL); Mark Johannes Boerakker, Eindhoven (NL); Gerard Joseph Emile Drummen, Maastricht (NL)

(21) Appl. No.: 19/103,322

(22) PCT Filed: Aug. 14, 2023
(86) PCT No.: PCT/EP2023/072410

§ 371 Date: Feb. 12, 2025

(30) Foreign Application Priority Data
Aug. 24, 2022 (EP) 22192035.8

(51) Int. Cl. F24T 10/13; B29C 55/00; B29C 55/26; B29K 23/00; B29L 23/00; F24T 10/00

(52) U.S. Cl. CPC F24T 10/13; B29C 55/005; B29C 55/26; B29K 2023/065; B29K 2023/12; B29K 2995/0097; B29L 2023/22; F24T 2010/50

(57) ABSTRACT

A geothermal heating and cooling system comprising a conduit comprising a biaxially oriented pipe made by a process comprising a) forming a polymer composition comprising an ethylene-based polymer and/or a propylene-based polymer into a tube and b) stretching the tube in the axial direction and in the peripheral direction to obtain the biaxially oriented pipe.

### CROSS REFERENCE TO RELATED APPLICATIONS

This application is a National Stage application of PCT/EP2023/072410, filed Aug. 14, 2023, which claims the benefit of European Application No. 22192035.8, filed Aug. 24, 2022, both of which are incorporated by reference in their entirety herein.

### BACKGROUND

The present invention relates to a geothermal heating and cooling system.

Geothermal heating and cooling systems use the earth as both a heat source and a heat sink. Geothermal heating and cooling systems circulate a water-based solution through a conduit comprising pipes buried in the ground. A high heat transfer efficiency of the pipe is important for decreasing the length of the pipe to decrease the cost of the installation.

Improvements in the structure of the conduit in geothermal heating and cooling systems have been made in the art for improving heat transfer efficiency. For example, WO2011/104607 discloses a conduit comprising 2 or more pipes that are twisted together for improving heat transfer efficiency. WO2011/104607 mentions that the pipes useful in the disclosure are plastic and that polyethylene and cross-linked high-density polyethylene are preferred. Although the structure of the conduit is important for heat transfer efficiency, another important factor is the material from which the pipes are made.

US2011/0011558 discloses a geothermal system for heating and cooling building structures, comprising a plastic pipe embedded with heat transfer particulates; and the pipe having a modulus of elasticity less than 200,000 psi.

A geothermal heating system can utilize a higher temperature of the ground by installing the pipe deeper into the ground since the ground temperature increases with depth. After a depth of about 15 meters, the ground temperature increases by one degree every 30 meters. However, the pressure experienced by the pipe also increases with depth. Commonly used geothermal probe pipes are made of materials having an MRS value of 10 MPa and have a ratio of the outer diameter (D) to the wall thickness (W) (commonly referred as SDR) of about 11. This ensures that the borehole heat exchanger pipe can withstand a pressure of 16 bar, resulting in a usable depth of about 160 m. For a deeper lowered geothermal probe pipe, considerably higher hydrostatic internal pressure is encountered. According to one of the current practice use of a conical pipe, increasing the wall thickness of pipe as it goes deeper in the ground is suggested in EP 2706308. This is a cumbersome approach and restricts the fluid volumetric flow if the inner diameter is reduced. It is difficult to coil and install such pipe if the outer diameter is gradually increased.

The type of ground is a determining factor for whether a geothermal heating and cooling system can be used for a sufficient period in that ground. After installation of the pipe in the ground, the pipe constantly receives pressure from the surrounding environment. The pressure from the surrounding environment varies depending on the type of the ground. For example, rocks in the surrounding soil exert larger external point load than sand. The external point load is further increased by movement of the ground, e.g. by earthquake.

Cracks form on the external surface of the pipe which has received a large external point load, which leads to failure of the pipe. Accordingly, rocky environments require the pipe to have a higher resistance to external point load. Higher resistance to external point load is therefore necessary to allow installation in diverse types of environments.

It is an object of the present invention to provide a geothermal heating and cooling system in which above-mentioned and/or other problems are solved.

### SUMMARY

Accordingly, the invention provides a geothermal heating and cooling system comprising a conduit comprising a biaxially oriented pipe made by a process comprising a) forming a polymer composition into a tube and b) stretching the tube in the axial direction and in the peripheral direction to obtain the biaxially oriented pipe.

### DETAILED DESCRIPTION

The present inventors have realized that the use of a biaxially oriented pipe in a geothermal heating and cooling system leads to various advantages.

The heat conduction through the pipe wall is inversely proportional to the wall thickness of the pipe i.e. a lower wall thickness leads to a higher heat conduction. However, a lower wall thickness leads to a lower resistance to the internal pressure of the pipe. The present inventors have realized that a biaxially oriented pipe has a higher internal pressure resistance than a conventional pipe at the same wall thickness and thus a reduced wall thickness may be used for a biaxially oriented pipe to withstand the same internal pressure. The reduced wall thickness results in a higher thermal conductivity. At the same outer diameter, the reduced wall thickness also results in a higher fluid capacity.

The higher resistance to pressure is particularly important in a geothermal heating and cooling system in which the resistance of the pipe to internal pressure determines the depth to which the pipe can be installed. For installing the biaxially oriented pipe to the same depth as a conventional pipe, the biaxially oriented pipe can be made to have a larger SDR than the conventional pipe. This is advantageous for the thermal conductivity. Further, the higher internal pressure resistance of the biaxially oriented pipe allows installing the biaxially oriented pipe to a deeper ground than a conventional pipe having the same SDR. This is advantageous for utilizing the higher temperature of the deeper ground.

Further, the biaxially oriented pipe has shown tremendous resistance to point loads which might be encountered in the borehole. Accordingly, the present invention provides a geothermal heating and cooling system which efficiently utilizes geothermal heat even in environments in which the pipe is subjected to large external point load, for example rocky soils.

### Geothermal Heating and Cooling System

A geothermal heating and cooling system is per se well-known and is described e.g. in US2011011558 in particular referring to the figures. The conduit of the system according to the invention comprises a closed loop comprising a part made of the biaxially oriented pipe. The system comprises a suitable means for circulating a fluid through the conduit. The direction of the circulation of the fluid depends on whether the system is used for heating or cooling. The conduit is connected to a heat pump or other fluid heat exchanger for a building or other structure to be heated or cooled. According to the invention, at least the part of the conduit to be placed underground comprises a part made of the biaxially oriented pipe.

In some embodiments, the system is a vertical system. In a vertical system, the conduit comprises a first vertically disposed pipe having a first outer diameter D1 and a first wall thickness W1 configured for passing a fluid downwards (inflow pipe), a second vertically disposed pipe having a second outer diameter D2 and a second wall thickness W2 configured for passing a fluid upwards (return flow pipe) and a U-shaped connecting pipe connecting the first vertical pipe and the second vertical pipe at their lower ends. D1/W1 may be larger than, equal to or smaller than D2/W2.

Preferably, at least the first vertically disposed pipe is the biaxially oriented pipe. In some embodiments, the first vertically disposed pipe is the biaxially oriented pipe and the second vertically disposed pipe is the biaxially oriented pipe. In some embodiments, the first vertically disposed pipe is the biaxially oriented pipe and the second vertically disposed pipe is a uniaxially oriented pipe.

It is desirable if the first vertically disposed pipe has a high heat conduction since the heat transfer between the fluid in the first vertically disposed pipe and the surrounding environment becomes efficient. It is not necessary that the second vertically disposed pipe has a high heat conduction since the temperature of the fluid transported towards the building should be maintained. Accordingly, preferably D1/W1 is larger than D2/W2.

In some embodiments, the system is a horizontal system.

### Biaxially Oriented Pipe

Preferably, the biaxially oriented pipe has a substantially constant ratio of the outer diameter to the wall thickness, e.g. the deviation of said ratio over the longitudinal direction of the pipe is at most 5%.

The biaxially oriented pipe consists of a biaxially oriented polymer composition made from the polymer composition comprising an ethylene-based polymer and/or a propylene-based polymer.

Preferably, the biaxially oriented pipe has an MRS value of at least 10.0 MPa at 20° C. over a period of 50 years, more preferably at least 12.0 MPa at 20° C. over a period of 50 years, more preferably at least 14.0 MPa at 20° C. over a period of 50 years, at least 16.0 MPa at 20° C. over a period of 50 years.

Preferably, the biaxially oriented pipe has an outer diameter of 25 mm to 250 mm, preferably 25 mm to 63 mm, more preferably 25 mm to 50 mm or 25 mm to 35 mm.

Preferably, the biaxially oriented pipe has a ratio of the outer diameter to the wall thickness (SDR) of 5.0 to 20, preferably 7.0 to 20.

In some preferred embodiments, at least part of the biaxially oriented pipe is located at a depth of 100 to 160 m and has a ratio of the outer diameter to the wall thickness of 11 to 17.

In some preferred embodiments, at least part of the biaxially oriented pipe is located at a depth of 160 to 256 m and has a ratio of the outer diameter to the wall thickness of 5 to 11.

Preferably, the biaxially oriented pipe has an outer diameter of 25 mm to 250 mm, preferably 25 mm to 63 mm, more preferably 25 mm to 50 mm or 25 mm to 35 mm, and a ratio of the outer diameter to a wall thickness (SDR) of 5.0 to 20, preferably 7.0 to 20, more preferably 11 to 20, and has a time to failure of at least 500 hours, more preferably at least 1000 hours, preferably at least 2000 hours, more preferably at least 3000 hours, according to the accelerated point load test in accordance with PAS1075:2009, particularly the test instructions in Annex A3 regarding Point load testing on a full walled pipe at a hoop stress of 4 MPa and at a temperature of 90° C. in an aqueous solution of NM5.

Preferably, the biaxially oriented pipe has an outer diameter of 25 to 35 mm, for example 32 mm and a ratio of the outer diameter to a wall thickness (SDR) of 15 to 20, for example 17, and has a time to failure of at least 500 hours, more preferably at least 1000 hours, preferably at least 2000 hours, more preferably at least 3000 hours, according to the accelerated point load test in accordance with PAS1075:2009, particularly the test instructions in Annex A3 regarding Point load testing on a full walled pipe at a hoop stress of 4 MPa and at a temperature of 90° C. in an aqueous solution of NM5.

### Ethylene-Based Polymer

Preferably, the polymer composition comprises an ethylene-based polymer.

In some embodiments, the amount of the ethylene-based polymer with respect to the total amount of polymers in the polymer composition is at least 95 wt %, at least 98 wt %, at least 99 wt % or 100 wt %.

In some embodiments, the amount of the ethylene-based polymer with respect to the polymer composition is at least 90 wt %, at least 95 wt %, at least 98 wt %, at least 99 wt % or 100 wt %.

Preferably, the ethylene-based polymer comprises a high-density polyethylene (HDPE).

In some embodiments, the amount of the HDPE with respect to the total amount of polymers in the polymer composition is at least 95 wt %, at least 98 wt %, at least 99 wt % or 100 wt %.

In some embodiments, the amount of the HDPE with respect to the polymer composition is at least 90 wt %, at least 95 wt %, at least 98 wt %, at least 99 wt % or 100 wt %.

In some embodiments, the ethylene-based polymer comprises a further polyethylene other than HDPE. The further polyethylene may e.g. be linear low-density polyethylene (LLDPE), low-density polyethylene (LDPE) or a combination of LLDPE and LDPE.

Preferably, the further polyethylene is LLDPE or a combination of LLDPE and LDPE. More preferably, the further polyethylene is LLDPE. In case the further polyethylene is a combination of LLDPE and LDPE, the weight ratio of LLDPE to LDPE may e.g. be at least 0.1, for example at least 0.2 or at least 0.3 and at most 10, for example at most 5 or at most 3. Preferably, the weight ratio of LLDPE to LDPE is at least 1, for example 2 to 10.

Preferably, the weight ratio of HDPE to the further polyethylene is more than 1, preferably 1.2-5, for example 1.5-4 or 2-3. In some embodiments, the ethylene-based polymer essentially comprises no further polyethylene other than HDPE. The amount of HDPE with respect to the total ethylene-based polymer in the polymer composition may be at least 95 wt %, at least 98 wt %, at least 99 wt % or 100 wt %.

Preferably, the polymer composition has a Melt Flow Rate of 0.1-4.0 g/10 min, more preferably 0.1-1.0 g/10 min, measured according to ISO1133-1:2011 (190° C./5 kg).

The production processes of HDPE, LLDPE and LDPE are summarised in Handbook of Polyethylene by Andrew Peacock (2000; Dekker; ISBN 0824795466) at pages 43-66

### HDPE

Preferably, the HDPE is bimodal or multimodal (e.g. trimodal). Such HDPEs have properties suitable for producing a pipe. Furthermore, the bimodalty or multimodalty of the HDPE may allow such HDPEs to be drawn at a low draw ratio without causing the necking problem.

It is understood that a bimodal HDPE has a molecular weight distribution having two peaks corresponding to the first median and the second median of the respective stages in the polymerization. It is similarly understood that a multimodal HDPE has a molecular weight distribution having multiple peaks corresponding to the first median, the second median and one or more further medians of the respective stages in the polymerization.

HDPE may be an ethylene homopolymer or may comprise a comonomer, for example 1-butene or 1-hexene.

Preferably, the HDPE has a density of 940-960 kg/m³, more preferably 940-955 kg/m³, measured according to ISO1183.

Preferably, the HDPE has a Melt Flow Rate of 0.1-4.0 g/10 min, more preferably 0.1-1.0 g/10 min, measured according to ISO1133-1:2011 (190° C./5 kg).

Preferably, the HDPE has a Melt Flow Rate of 5-15 g/10 min, more preferably 0.1-1.0 g/10 min, measured according to ISO1133-1:2011 (190° C./21.6 kg).

In some embodiments, the composition comprises a compound comprising the HDPE and a colorant, wherein the compound has a density of 947-965 kg/m³ measured according to ISO1183. The colorant may e.g. be carbon black or a pigment having a color of e.g. black, blue or orange. The amount of the colorant is typically 1.0-5.0 wt %, more typically 2.0-2.5 wt %, with respect to the compound comprising the HDPE and the colorant, the rest typically being the HDPE.

The HDPE can be produced by using low pressure polymerisation processes. For example, pipe materials of the performance class PE 80 and PE 100 are known, which are generally produced in cascade plants by a so-called bimodal or multimodal process. The production processes for bimodal HDPE are summarised at pages 16-20 of “PE 100 Pipe systems” (edited by Bromstrup; second edition, ISBN 3-8027-2728-2). Suitable low pressure processes are slurry cascade of stirred reactors, slurry cascade of loop reactors and a combination of different processes such as slurry loop gas phase reactor. It is also possible to use a multimodal polyethylene, preferably trimodal polyethylene, as described for example in WO2007003530, as high density polyethylene pipe material.

The performance classes PE 80 and PE 100 are discussed at pages 35-42 of “PE 100 Pipe systems” (edited by Bromstrup; second edition, ISBN 3-8027-2728-2). The quality test methods are described at pages 51-62 of “PE 100 Pipe systems”.

The production of bimodal high density polyethylene (HDPE) via a low pressure slurry process is described by Alt et al. in “Bimodal polyethylene-Interplay of catalyst and process” (Macromol. Symp. 2001, 163, 135-143). In a two-stage cascade process the reactors may be fed continuously with a mixture of monomers, hydrogen, catalyst/co-catalyst and hexane recycled from the process. In the reactors, polymerisation of ethylene occurs as an exothermic reaction at pressures in the range between for example 0.5 MPa (5 bar) and 1 MPa (10 bar) and at temperatures in the range between for example 75° C. and 85° C. The heat from the polymerisation reaction is removed by means of cooling water. The characteristics of the polyethylene are determined amongst others by the catalyst system and by the applied concentrations of catalyst, co monomer and hydrogen. The concept of the two stage cascade process is elucidated at pages 137-138 by Alt et al. “Bimodal polyethylene-Interplay of catalyst and process” (Macromol. Symp. 2001, 163). The reactors are set up in cascade with different conditions in each reactor including low hydrogen content in the second reactor. This allows for the production of HDPE with a bimodal molecular mass distribution and defined co monomer content in the polyethylene chains in each reactor.

Preferred examples of the HDPE include a bimodal PE 80, a bimodal PE 100 and a multimodal HDPE. PE 80 is a PE material with an MRS (minimum required strength after 50 years for water at 20 degrees Celsius) of 8 MPa and PE 100 is a PE material with an MRS of 10 MPa. The pipe classification is elucidated at page 35 of “PE 100 Pipe systems” (edited by Bromstrup; second edition, ISBN 3-8027-2728-2).

Preferably, the HDPE or the compound comprising the HDPE and the colorant has one or more of, preferably all of, the following characteristics:
Tensile modulus of 500-1400 MPa, preferably 700-1200 MPa (according to ISO 527-2)
Yield stress of 15-32 MPa, preferably 18-28 MPa (according to ISO 527-2) —Full Notch Creep Test (FNCT): 100-20000 h (according to ISO 16770 @ 80 degrees centigrade/4 MPa).

It is noted that a bimodal or multimodal HDPE is to be herein understood as a polyethylene made in a reactor cascade wherein a first type of polyethylene is prepared in a first reactor and transferred to a subsequent reactor and a second type of polyethylene is prepared in the subsequent reactor in the presence of the first type of polyethylene. Thus a bimodal or multimodal HDPE does not include a blend of different types of polyethylene obtained independently.

### LLDPE

The ethylene-based polymer may comprise LLDPE.

The technologies suitable for the LLDPE manufacture include gas-phase fluidized-bed polymerization, polymerization in solution, polymerization in a polymer melt under very high ethylene pressure, and slurry polymerization.

The LLDPE comprises ethylene and a C3-C10 alpha-olefin comonomer (ethylene-alpha olefin copolymer). Suitable alpha-olefin comonomers include 1-butene, 1-hexene, 4-methyl pentene and 1-octene. The preferred co monomer is 1-hexene.

Preferably, the alpha-olefin co monomer is present in an amount of about 5 to about 20 percent by weight of the ethylene-alpha olefin copolymer, more preferably an amount of from about 7 to about 15 percent by weight of the ethylene-alpha olefin copolymer.

Preferably, the LLDPE has a density of 900-940 kg/m³, more preferably 915-935 kg/m³, more preferably 920-935 kg/m³, determined according to ISO1872-2.

Preferably, the LLDPE has a Melt Flow Rate of 0.1-3.0 g/10 min, more preferably 0.3-3.0 g/10 min, determined according to ISO1133-1:2011 (190° C./2.16 kg).

### LDPE

The ethylene-based polymer may comprise LDPE.

The LDPE may be produced by use of autoclave high pressure technology and by tubular reactor technology.

LDPE may be an ethylene homopolymer or may comprise a comonomer, for example 1-butene or 1-hexene.

Preferably, the LDPE has a density of 916-940 kg/m³, more preferably 920-935 kg/m³, determined according to ISO1872-2. Preferably, the LDPE has a Melt Flow Rate of 0.1-3.0 g/10 min, more preferably 0.3-3.0 g/10 min, determined according to ISO1133-1:2011 (190° C./2.16 kg).

### Propylene-Based Polymer

In some embodiments, the polymer composition comprises a propylene-based polymer.

In some embodiments, the amount of the propylene-based polymer with respect to the total amount of polymers in the polymer composition is at least 95 wt %, at least 98 wt %, at least 99 wt % or 100 wt %.

In some embodiments, the amount of the propylene-based polymer with respect to the polymer composition is at least 90 wt %, at least 95 wt %, at least 98 wt %, at least 99 wt % or 100 wt %.

The propylene-based polymer may comprise or may be a propylene copolymer selected from random copolymers, (multi) block copolymers and heterophasic propylene copolymers and combinations thereof. The propylene-based polymer may further comprise a propylene homopolymer.

### Non-Heterophasic Propylene Copolymer

The polypropylene-based polymer may comprise or may be a propylene copolymer including random copolymers and (multi) block copolymers.

The copolymer is preferably a random copolymer. The copolymer may consist of at least 70 wt % of propylene monomer units and up to 30 wt % of ethylene and/or α-olefin monomer units, based on the total weight of the copolymer. Preferably, the α-olefin is selected from the group of α-olefins having 4-10 carbon atoms, for example 1-butene, 1-pentene, 4-methyl-1-pentene, 1-hexene, 1-heptene or 1-octene. The propylene copolymer is preferably a propylene-ethylene copolymer.

The amount of ethylene and/or α-olefin monomer units in the propylene copolymer is preferably 1-15 wt %, more preferably 1-10 wt %, more preferably 1-6 wt %, more preferably 1-4 wt % based on the total weight of the propylene copolymer. When the polypropylene-based polymer comprises a propylene α-olefin copolymer, the propylene copolymer is preferably a propylene-ethylene random copolymer wherein the amount of ethylene monomer units is 1-15 wt %, more preferably 1-10 wt %, more preferably 1-6 wt %, more preferably 1-4 wt % based on the total weight of the propylene copolymer.

The MFI of some preferred propylene copolymer may be for example 0.1 to 10.0 dg/min, preferably 0.4 to 4.0 dg/min, more preferably 0.1 to 1.0 dg/min, measured according to ISO1133-1:2011 (2.16 kg/230° C.).

In some preferred embodiments, the propylene-based polymer is or comprises a mixture of a propylene homopolymer and a propylene copolymer such as a propylene-ethylene copolymer.

### Heterophasic Propylene Copolymer

The polypropylene-based polymer may comprise or may be a heterophasic propylene copolymer consisting of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %.

The heterophasic propylene copolymer of the composition of the invention consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-a-olefin copolymer may be determined by ¹³C-NMR, as well known in the art.

The propylene-based matrix consists of a propylene homopolymer and/or a propylene copolymer consisting of at least 90 wt % of propylene monomer units and at most 10 wt % of comonomer units selected from ethylene monomer units and α-olefin monomer units having 4 to 10 carbon atoms, for example consisting of at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer.

Preferably, the propylene-based matrix is present in an amount of 60 to 98 wt %, for example at most 97 wt %, at most 96 wt %, at most 95 wt %, at most 93 wt % or at most 91 wt %, based on the total heterophasic propylene copolymer. Preferably, the propylene-based matrix is present in an amount of at least 70 wt %, more preferably at least 75 wt %, for example at least 80 wt %, at least 85 wt %, at least 87 wt % or at least 90 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

Preferably, the amount of ethylene monomer units in the ethylene-α-olefin copolymer is 5 to 65 wt %, for example at least 10 wt %, at least 20 wt %, at least 30 wt %, at least 40 wt % or at least 45 wt % and/or at most 60 wt %, at most 58 wt %, at most 55 wt % or at most 50 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

Preferably, the dispersed ethylene-α-olefin copolymer is present in an amount of 2.0 to 40 wt %, for example at least 3.0 wt %, at least 4.0 wt %, at least 5.0 wt %, at least 7.0 wt % or at least 9.0 wt %, based on the total heterophasic propylene copolymer. Preferably, the dispersed ethylene-α-olefin copolymer is present in an amount of at most 30 wt %, more preferably at most 25 wt %, for example at most 20 wt %, at most 15 wt %, at most 13 wt % or at most 10 wt %, based on the total heterophasic propylene copolymer.

In the heterophasic propylene copolymer in the composition of the invention, the sum of the total weight of the propylene-based matrix and the total weight of the dispersed ethylene-α-olefin copolymer is 100 wt % of the heterophasic propylene copolymer.

Preferably, the MFI of the heterophasic propylene copolymer is 0.1 to 10.0 g/10 min, more preferably 0.1 to 4.0 g/10 min, particularly preferably 0.1 to 1.0 g/10 min, measured according to ISO1133-1:2011 (230° C./2.16 kg).

### Other Components

The polymer composition may comprise components other than the ethylene-based polymer and the propylene-based polymer, such as additives and fillers. Examples of the additives include nucleating agents; stabilisers, e.g. heat stabilisers, anti-oxidants, UV stabilizers; colorants, like pigments and dyes; clarifiers; surface tension modifiers; lubricants; flame-retardants; mould-release agents; flow improving agents; plasticizers; anti-static agents; external elastomeric impact modifiers; blowing agents; and/or components that enhance interfacial bonding between polymer and filler, such as a maleated polyethylene. The amount of the additives is typically 0 to 5.0 wt %, for example 1.0 to 3.0 wt %, with respect to the total composition.

Examples of fillers include glass fibers, talc, mica, nanoclay. The amount of fillers is typically 0 to 40 wt %, for example 5 to 30 wt % or 10 to 25 wt %, with respect to the total polymer composition.

Accordingly, in some embodiments, the polymer composition further comprises 0 to 5.0 wt % of additives and 0 to 40 wt % of fillers.

The polymer composition may be obtained by melt-mixing the ethylene-based polymer and/or the propylene-based polymer, optionally with any other optional components.

Preferably, the total amount of the ethylene-based polymer, the propylene-based polymer, the optional additives and the optional fillers is 100 wt % with respect to the total polymer composition.

### Process Steps

The biaxially oriented pipe is made by a process comprising the steps of: a) forming a polymer composition into a tube and b) stretching the tube of step a) in the axial direction and in the peripheral direction to obtain the biaxially oriented pipe. The process for making the pipe may be performed as a continuous process or a batch-wise process. A continuous process is herein understood as a process wherein the polymer composition is continuously fed for the tube making step a), while the drawing step b) is continuously performed. The polymer composition may be formed into a tube (step a) by any known method, such as extrusion or injection moulding. The biaxial elongation (step b) may be performed by any known method. Preferably, no crosslinking is performed on the tube obtained by step a).

The terms “pipe” and “tube” are herein understood as a hollow elongated article, which may have a cross section of various shapes. The cross section may e.g. be circular, elliptical, square, rectangular or triangular. The term “diameter” is herein understood as the largest dimension of the cross section.

Methods for forming the polymer composition into a tube and the biaxial elongation of the tube are described in U.S. Pat. No. 6,325,959:

A conventional plant for extrusion of plastic pipes comprises an extruder, a nozzle, a calibrating device, cooling equipment, a pulling device, and a device for cutting or for coiling-up the pipe.

To achieve biaxial orientation, this plant can be supplemented, downstream of the pulling device, with a device for temperature control of the pipe to a temperature that is suitable for biaxial orientation of the pipe, an orienting device, a calibrating device, a cooling device, and a pulling device which supplies the biaxially oriented pipe to a cutting device or coiler.

The biaxial orientation of the pipe can be carried out in various ways, for instance mechanically by means of an internal mandrel, or by an internal pressurised fluid, such as air or water or the like. A further method is the orienting of the pipe by means of rollers, for instance by arranging the pipe on a mandrel and rotating the mandrel and the pipe relative to one or more pressure rollers engaging the pipe, or via internally arranged pressure rollers that are rotated relative to the pipe against an externally arranged mould or calibrating device.

Further, Morath et al., Biaxially oriented polypropylene pipes, Plastics, Rubber and Composites 2006 vol 35 no 10, p. 447-454 describes a process for making a biaxially oriented pipe from a random propylene copolymer.

### Conditions for Step b)

The skilled person can select suitable conditions such as temperatures for step b) to obtain a biaxially oriented pipe. Step b) is performed at a drawing temperature which results in orientation of the ethylene-based polymer and the propylene-based polymer in the polymer composition.

The drawing temperature is selected according to the melting point of the ethylene-based polymer and the propylene-based polymer in the polymer composition.

### Tm and Td

The melting point Tm of the polymer composition is determined by differential scanning calorimetry according to ASTM D3418. The DSC measurements are performed using a DSC TA Q20 and an Intracooler capable of reaching −90° C. The measurements are done under nitrogen flow to avoid degradation. The methodology followed is:
First Heating: −40° C. to 230° C. @ 10° C./min (3 min hold at the end temperature)
Cooling: 230° C. to −40° C. @ 10° C./min
Second Heating: −40° C. to 230° C. @ 10° C./min
Sample used are between 3 and 5 mg
Melting point is the peak melting temperature observed in the second heating cycle.

When the polymer composition comprises different propylene-based polymers or different ethylene-based polymers, more than one melting peak may be observed in the second heating cycle. In this case, the melting peak which belongs to a propylene-based polymer or an ethylene-based polymer which is present in the composition in the highest amount defines the Tm of the polymer composition. If there are more than one propylene-based or ethylene-based polymer present in the highest amounts (e.g. a blend of 50 wt % of a first propylene-based polymer and 50 wt % of a second propylene-based polymer or a blend of 40 wt % of a first propylene-based polymer, 40 wt % of a second propylene-based polymer and 20 wt % of a third propylene-based polymer), the highest temperature among the temperatures of the melting peaks of said polymers present in the highest amounts is defined as the Tm of the polymer composition.

Before drawing, the tube of step a) is heated so that they have the desired drawing temperature. This may be done by soaking the tube of step a) at the desired drawing temperature for a period sufficient to attain thermal equilibrium, e.g. 30 minutes. The temperature of the tube is preferably controlled within +1° C.

The drawing temperature may be selected to be lower than the melting point of the propylene-based polymer in the polymer composition.

The drawing temperature may be 1 to 30° C., for example 2 to 20° C. or 3 to 10° C., lower than the melting point of the polymer composition.

In some embodiments wherein the amount of the propylene-based polymer with respect to the total amount of polymers in the polymer composition is at least 95 wt %, step b) is performed at a drawing temperature of 140 to 160° C., preferably 145 to 155° C.

The drawing temperature may be selected to be equal to or higher than the melting point of the polymer composition when the polymer composition comprises the propylene-based polymer which comprises the heterophasic propylene copolymer.

For example, Td is equal to or higher than Tm. For example, Td≥Tm+0.1° C., Td≥Tm+0.3° C., Td≥Tm+0.5° C., Td≥Tm+1.0° C., Td≥Tm+2.0° C., Tm+3.0° C., Td≥Tm+5.0° C., Td≥Tm+8.0° C. or Td≥Tm+10.0° C. Preferably, Tm+1.0° C.≤Td≤Tm+15.0° C. More preferably, Tm+1.0° C.≤Td≤Tm+10.0° C.

In some embodiments, Tm is 150 to 165° C. and Td is 150 to 170° C., wherein Tm≤Td≤Tm+15.0° C.

### Draw Ratios

Typically, step b) is performed at an axial draw ratio of more than 1.0, for example 1.1 to 5.0 and an average hoop draw ratio of more than 1.0, for example 1.1 to 3.0.

Preferably, the average hoop draw ratio of 1.1 to 2.0.

Preferably, the axial draw ratio of 1.1 to 4.0, for example 1.1 to 3.6 or 1.1 to 3.2. The axial draw ratio is typically larger for obtaining a biaxially oriented pipe with a higher outer diameter.

The axial draw ratio of the drawn pipe is defined as the ratio of the cross-sectional area of the starting isotropic tube to that of the biaxially oriented pipe (i.e. product), that is,

$${λ}_{axial} = \frac{{( Tube OD )}^{2} - {( Tube ID )}^{2}}{{( Product OD )}^{2} - {( Product ID )}^{2}}$$

OD stands for outer diameter and ID stands for inner diameter.

In the case of expanded tube drawing, the hoop draw ratio of the product varies from the inner to the outer wall. These draw ratios are defined as:

$${λ}_{hoop , inner} = \frac{Product ID}{Tube ID}$$

$${λ}_{h oop , outer} = \frac{Product OD}{Tube OD}$$

The average hoop draw ratio can be defined as:

$${λ}_{average hoop} = \frac{Total Draw Ratio {λ}_{Total}}{Axial Draw Ratio {λ}_{axial}}$$

$$Where$$

$${λ}_{Total} = \frac{Tube Wall Thickness}{Product Wall Thickness}$$

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### Materials:

HDPE1: A Continuous Stirred Tank Reactor (CSTR) reactor with 20 liters total volume and 15 liters of operating volume was used to prepare a trimodal HDPE with a final density of 948 kg/m³, a melt index (21.6 kg, 190° C.) of 11.2 and a melt index (5 kg, 190° C.) of 0.48. The catalyst applied was a commercial Ziegler-Natta catalyst/co-catalyst system.

### Procedure:

HDPE1 was made into granules using a twin screw extruder. Processing temperature and screw profile were of standard polyethylene compounding.

These compounded granules were used to produce thick tubular profiles of approximate dimensions of an outer diameter of about 32 mm and an inner diameter of about 16 mm. These thick tubes were drawn over an expanding conical mandrel of exit diameter of 32 mm and semi angle 15 degree at temperature of 120° C. at a draw speed of 100 mm/min. Axial draw ratio was 3.2 and the average hoop draw ratio was 1.25. A biaxially oriented pipe having an outer diameter of 32 mm and a wall thickness of 2 mm was obtained.

The sample ‘Isotropic pipe’ was made from HDPE1 into a pipe having an outer diameter of 32 mm and a wall thickness of 2.9 mm by an extrusion without the stretching step.

### Internal Pressure Test

Internal pressure tests were carried out at 20° C. on the biaxially oriented pipe and the isotropic pipe according to ISO 9080 under pressures shown in Table 1. Results are given in Table 1

TABLE 1

| Sample | Stress (MPa) | Time to Failure (h) | Mode of Failure |
|---|---|---|---|
| Isotropic pipe | 17 | Instant | Ductile |
| Biaxially oriented | 17 | >25210 under test | — |
| pipe | | | |
| Biaxially oriented | 19 | 12100 | Ductile |
| pipe | | | |
| Biaxially oriented | 20 | 8050 | Ductile |
| pipe | | | |

### Accelerated Point Load Test (PLT+)

Accelerated point load tests were carried out on the biaxially oriented pipe and the isotropic pipe in accordance with PAS1075:2009, particularly the test instructions in Annex A3 regarding Point load testing on a full walled pipe. The tests were performed at a hoop stress of 4 MPa and at a temperature of 90° C. in an aqueous solution of NM5.

| Sample | Time to failure (h) |
|---|---|
| Isotropic pipe | <400 |
| Biaxially oriented pipe | >5975 |

1. A geothermal heating and cooling system comprising a conduit comprising a biaxially oriented pipe made by a process comprising a) forming a polymer composition comprising an ethylene-based polymer and/or a propylene-based polymer into a tube and b) stretching the tube in the axial direction and in the peripheral direction to obtain the biaxially oriented pipe.

2. The system according to claim 1, wherein the biaxially oriented pipe has an outer diameter of 25 to 250 mm and/or a ratio of the outer diameter to a wall thickness (SDR) of 5.0 to 20.

3. The system according to claim 1, wherein the biaxially oriented pipe has an MRS value of at least 10.0 MPa at 20° C. over a period of 50 years.

4. The system according to claim 1, wherein the biaxially oriented pipe has an outer diameter of 25 mm to 63 mm and a ratio of the outer diameter to a wall thickness (SDR) of 11 to 20 and has a time to failure of at least 500 hours, according to the accelerated point load test in accordance with PAS1075:2009, Annex A3 at a hoop stress of 4 MPa and at a temperature of 90° C.

5. The system according to claim 1, wherein the biaxially oriented pipe has an outer diameter of 25 to 35 mm and a ratio of the outer diameter to a wall thickness (SDR) of 15 to 20 and has a time to failure of at least 500 hours, according to the accelerated point load test in accordance with PAS1075:2009, Annex A3 at a hoop stress of 4 MPa and at a temperature of 90° C.

6. The system according to claim 1, wherein the system is a vertical system.

7. The system according to claim 6, wherein the conduit comprises a first vertically disposed pipe having a first outer diameter D1 and a first wall thickness W1 configured for passing a fluid downwards, a second vertically disposed pipe having a second outer diameter D2 and a second wall thickness W2 configured for passing a fluid upwards and a U-shaped connecting pipe connecting the first vertical pipe and the second vertical pipe at their lower ends, wherein at least the first vertically disposed pipe is the biaxially oriented pipe.

8. The system according to claim 7, wherein D1/W1 is larger than D2/W2.

9. The system according to claim 8, wherein D1/W1 is 13 to 20 and D2/W2 is 7 to 13.

10. The system according to claim 1, wherein the system is a horizontal system.

11. The system according to claim 1, wherein the ethylene-based polymer comprises a high-density polyethylene (HDPE).

12. The system according to claim 1, wherein the amount of the ethylene-based polymer with respect to the total amount of polymers in the polymer composition is at least 95 wt %.

13. The system according to claim 1, wherein the amount of the propylene-based polymer with respect to the total amount of polymers in the polymer composition is at least 95 wt %.

14. The system according to claim 1, wherein no crosslinking is performed on the tube obtained by step a).

15. A method of transporting a fluid in a geothermal heating and cooling system comprising circulating the fluid through a biaxially oriented pipe, wherein the biaxially oriented pipe is made by a process comprising a) forming a polymer composition comprising a polyolefin into a tube, and b) stretching the tube in the axial direction and in the peripheral direction to obtain the biaxially oriented pipe.
